(19) United States
(12) Patent Application Publication
(10) Pub. No.: US 2010/0315443 A1
(43) Pub. Date: Dec. 16, 2010

(54) LIQUID CRYSTAL DISPLAY DEVICE AND METHOD FOR DRIVING LIQUID CRYSTAL DISPLAY DEVICE

(75) Inventors: Tomoo Furukawa, Osaka (JP); Kazuyoshi Fujioka, Osaka (JP)

Correspondence Address: HARNESS, DICKEY & PIERCE, P.L.C., P.O. BOX 8910, RESTON, VA, 20195, US

(73) Assignee: SHARP KABUSHKIK KAISHA, Osaka-shi, Osaka (JP)

(21) Appl. No.: 12/735,637

(22) PCT Filed: Nov. 6, 2008
(86) PCT No.: PCT/JP2008/070209

§ 371 Date: Aug. 4, 2010

(30) Foreign Application Priority Data
Mar. 7, 2008 (JP) 2008-058612

(51) Int. Cl. G09G 5/10; G09G 3/36

(52) U.S. Cl. 345/690; 345/87

(57) ABSTRACT

A liquid crystal display device displays an image by using overshoot driving. In at least one embodiment, the liquid crystal display device includes: a temperature sensor measuring a surface temperature of a liquid crystal panel; a gradation conversion section performing a gradation value shift process of shifting inputted gradation values to lower gradation values; and a pseudo-multi-gradating section performing a pseudo-multi-gradating process on image data on which the gradation value shift process has been performed by the gradation conversion section. The gradation conversion section decides whether or not to perform the gradation value shift process depending on the surface temperature of the liquid crystal panel measured by the temperature sensor.

### TECHNICAL FIELD

The present invention relates to a liquid crystal display device in which response speed of liquid crystal is improved by performing an overshoot drive, and to a method for driving the liquid crystal display device.

### BACKGROUND ART

In recent years, liquid crystal display devices (LCD) have come to be widely used as image display devices for PCs and TVs and are replacing image display devices of cathode ray tube (CRT) type. The LCDs are display devices configured by injecting, between two substrates, a liquid crystal layer having anisotropic permittivity. Adjusting strength of the electric field applied to the liquid crystal layer allows an amount of light passing through the substrates to be adjusted. As a result, a desired image signal is obtained.

Various studies are currently being made to improve performance of the LCDs. One of such studies is concerned with improvement of a response speed of the liquid crystal. In order to increase the response speed of the liquid crystal, a variety of attempts such as optimization of liquid crystal material and reduction in thickness of liquid crystal cells (cell gaps) are being made. On the other hand, there are studies being pursued that try to increase the response speed depending not on performance of the liquid crystal itself but on methods of driving the liquid crystal.

In order to remedy such problems of the response speed of the liquid crystal, there is a known liquid crystal driving method in which a liquid crystal display panel is supplied with, depending on a combination of an input image signal of an immediately preceding vertical period and an input image signal of the current vertical period, a predetermined driving voltage (overshot voltage) higher than a gradation voltage corresponding to the input image signal of the current vertical period. Such a liquid crystal driving method is generally called overshoot driving.

The overshoot driving increases the response speed in a case where gradation values shift from halftone to halftone. However, in a case where gradation values shift from arbitrary gradation values to gradation values indicative of a near black (or near white) display, the overshoot driving does not sufficiently function, because the gradation values after the shift are at the edge of the gradation range. This has been a problem that makes it difficult to increase the response speed.

Moreover, this problem becomes particularly prominent in a case where, for example, a liquid crystal display panel such as an in-vehicle liquid crystal display panel is put in a low-temperature state, i.e., a subfreezing condition or the like. This is because the response speed of the liquid crystal significantly decreases when gradation values are converted into gradation values indicative of white display, for the overshoot driving has little effect thereon.

The technique disclosed in Patent Literature 1 addresses such a problem of the response speed by reducing a dynamic range (a range in which gradations are used). Reducing the dynamic range makes it possible to overshoot the gradation shift to gradation values of black display side or gradation values of white display side, thereby increasing the response speed of the gradation shift to the black side or the white side. Further, in the liquid crystal display method described in Patent Literature 1, conversion characteristics of the foregoing dynamic range is controlled depending on the temperature of the liquid crystal panel, so that a decrease in the response speed at a low temperature is curbed.

### CITATION LIST

Patent Literature 1

Japanese Patent Application Publication Tokukai 2004-348151 A (Publication Date: Dec. 9, 2004)

Patent Literature 2

Japanese Patent Application Publication Tokukai 2005-10520 A (Publication Date: Jan. 13, 2005)

### SUMMARY OF INVENTION

However, in the method described in above Patent Literature 1, the reduction of the dynamic range causes the number of expressive gradations to decrease. This leads to problems of deterioration in gradation expression ability and an impairment of display quality.

Moreover, disregarding gradation values of the black side by not using the gradation values in a range from 0 to 15, for example, results in another problem that the black display becomes brighter and the contrast decreases.

The present invention is achieved in view of the above problems, and an object thereof is to provide a technique for curbing a decrease in the response speed of the gradation shift to white display at a low temperature and maintaining the gradation expression ability in a liquid crystal display device displaying an image by using overshoot driving.

In order to achieve the above object, a liquid crystal display device according to the present invention is a liquid crystal display device displaying an image by using overshoot driving, including: a temperature sensor measuring a surface temperature of a liquid crystal panel; a gradation conversion section performing a gradation value shift process of shifting inputted gradation values to lower gradation values; and a pseudo-multi-gradating section performing a pseudo-multi-gradating process on image data on which the gradation value shift process has been performed by the gradation conversion section, and the gradation conversion section decides whether or not to perform the gradation value shift process depending on the surface temperature of the liquid crystal panel measured by the temperature sensor.

Further, in order to achieve the above object, a method for driving a liquid crystal display device according to the present invention is a method for driving a liquid crystal display device displaying an image by using overshoot driving, the liquid crystal display device including a temperature sensor measuring a surface temperature of a liquid crystal panel, and the method includes: a gradation conversion step of deciding whether or not to perform a gradation value shift process for shifting inputted gradation values to lower gradation values depending on the surface temperature of the liquid crystal panel measured by the temperature sensor; and a pseudo-multi-gradating step of performing a pseudo-multi-gradating process on an image data on which the gradation value shift process has been performed in the gradation conversion step.

According to the above configuration or method, the gradation conversion section shifts the inputted gradation values to the gradation values lower than the inputted gradation values. This allows upper gradation values indicative of a near white display to be unused. Further, deciding whether or not to perform the gradation value shift process depending on the temperature of the liquid crystal panel makes it possible to display an image without using gradation values of high tone side (white display side) whose response speed decreases, in a case where the temperature decreases, particularly significantly because the overshoot driving is ineffective. Here, “deciding whether or not to perform the gradation value shift process depending on the temperature of the liquid crystal panel” means that, for example, the foregoing gradation value shift process is performed when the temperature of the liquid crystal panel is equal to or below a threshold value, and the foregoing gradation value shift process is not performed when the temperature of the liquid crystal panel is higher than the threshold value.

As described above, the gradation conversion section converts gradation values so that the gradation values of the whole image data are in a range from halftone equal to or below a predetermined gradation value to low tone. This eliminates high-tone part near white display with a low response speed from the image to be displayed, thereby making it possible to obtain an image with a high response speed.

Further, according to the above configuration or method, the pseudo-multi-gradating process is performed on the image data on which the gradation value shift process has been performed. This can curb a decrease in gradation expression ability caused by a decrease in the number of gradations in use. As a result, it is possible to curb deterioration in display quality in a case where the liquid crystal display device is put in a low-temperature environment.

In the liquid crystal display device according to the present invention, the gradation conversion section may perform the gradation value shift process when the surface temperature of the liquid crystal panel measured by the temperature sensor is 0° C. or below.

Further, in the method for driving a liquid crystal display device according to the present invention, in the gradation conversion step, the gradation value shift process may be performed when the surface temperature of the liquid crystal panel measured by the temperature sensor is 0° C. or below.

A guaranteed operating temperature range of a common liquid crystal display is between 0° C. and 60° C. Consequently, it is common to configure a liquid crystal display such that desired characteristics are obtained within this range. Meanwhile, a guaranteed operating temperature range of an in-vehicle liquid crystal panel is as wide as between −30° C. and 85° C., and it is the characteristics at 0° C. or below that often present a problem.

According to the above configuration or method, in a case where the temperature of the liquid crystal panel is 0° C. or below at which temperature the response speed decreases problematically, it is possible to curb the decrease in the response speed of the liquid crystal by performing the gradation value shift process. Therefore, the above configuration or method can be effectively used for an in-vehicle liquid crystal display device and the like.

The liquid crystal display device according to the present invention may further include: a backlight irradiating the liquid crystal panel with light; and a backlight driving section adjusting luminance of the light irradiated by the backlight, and in the liquid crystal device according to the present invention, the backlight driving section may adjust the luminance of the light irradiated by the backlight so that irradiation luminance is higher when the gradation conversion section performs the gradation value shift process than when the gradation conversion section does not perform the gradation value shift process.

In the method for driving a liquid crystal display device according to the present invention, the liquid crystal display device includes a backlight irradiating the liquid crystal panel with light, and the method further includes a backlight driving step of adjusting luminance of the light irradiated by the backlight, and the luminance of the light irradiated by the backlight may be adjusted in the backlight driving step so that irradiation luminance of the light is higher when the gradation value shift process is performed in the gradation conversion step than when the gradation value shift process is not performed in the gradation conversion step.

With the above configuration or method, it is possible to compensate for the decrease in luminance, which arises from the foregoing gradation value shift process causing the upper gradation values to be unused, by making the irradiation luminance of the backlight higher.

In the liquid crystal display device according to the present invention, the gradation conversion section performs the gradation value shift process of shifting the inputted gradation values to the lower gradation values while converting n-bit input image data (where n is an integer) into m-bit image data (where m is an integer) whose number of bits is larger than the number of bits of the n-bit input image data and outputting the m-bit image data; and the pseudo-multi-gradating section performs a pseudo-multi-gradating process on the m-bit image data so as to output as n-bit image data.

In the method for driving, a liquid crystal display device according to the present invention, in the gradation conversion step, n-bit input image data (where n is an integer) is converted into m-bit image data (where m is an integer) whose number of bits is larger than the number of bits of the n-bit input image data and the m-bit image data is outputted; and in a case where the gradation value shift process is performed, the gradation value shift process of shifting the inputted gradation values to the lower gradation values is performed while converting the n-bit input image data into m-bit image data; and in the pseudo-multi-gradating step, a pseudo-multi-gradating process is performed on the m-bit image data so as to output as n-bit image data.

According to the above configuration or method, the gradation conversion section performs the gradation conversion on n-bit input image data, and shifts the inputted gradation values to the lower gradation values, while outputting the m-bit image data into which the n-bit image data has been converted and whose number of bits is larger than the number of bits of the n-bit input image data. This makes it possible to curb the decrease in the number of gradations. In addition, it is possible to efficiently carry out the pseudo-multi-gradating process by performing the pseudo-multi-grading process on the m-bit image data.

Here, the aforementioned n and m are integers respectively representing number of bits, where m is larger than n. Specific examples of n and m includes a case where n is 6 and m is 8.

The liquid crystal display device according to the present invention may further include an overshoot calculation section performing an overshoot calculation on the image data on which the gradation value shift process has been performed by the gradation conversion section.

The method for driving a liquid crystal display device according to the present invention may further include an overshoot calculation step of performing an overshoot calculation on the image data on which the gradation value shift process has been performed in the gradation conversion step.

Furthermore, in order to achieve the above object, a liquid crystal display device according to the present invention is a liquid crystal display device displaying an image by using overshoot driving, including: a temperature sensor measuring a surface temperature of a liquid crystal panel; a gradation conversion section performing a gradation value shift process of shifting inputted gradation values to lower gradation values; a pseudo-multi-gradating section performing a pseudo-multi-gradating process on an image data on which the gradation value shift process has been performed by the gradation conversion section; a backlight irradiating the liquid crystal panel with light; and a backlight driving section adjusting luminance of the light irradiated by the backlight, and the gradation conversion section decides whether or not to perform the gradation value shift process depending on the surface temperature of the liquid crystal panel measured by the temperature sensor, and the backlight driving section adjusts the luminance of the light irradiated by the backlight so that irradiation luminance is higher when the gradation conversion section performs the gradation value shift process than when the gradation conversion section does not perform the gradation value shift process.

According to the above configuration, a high-tone part near white display with a low response speed is eliminated from the image to be displayed. As such, it is possible to obtain an image with a high response speed.

Moreover, according to the above configuration, the pseudo-multi-gradating process is performed on the image data on which the gradation value shift process has been performed, thereby making it possible to curb deterioration in gradation expression ability arising from a decrease in the number of the gradations in use. In consequence, it is possible to curb deterioration in the display quality in a case where the liquid crystal display device is put in a low-temperature environment.

Furthermore, making the irradiation luminance of the backlight higher makes it possible to compensate for a decrease in luminance arising from the shift process of the gradation values that causes the upper gradation values to be unused.

Other object, characteristics, and merits of the present invention will fully be understood by the following description. The advantages of the present invention will become apparent from the ensuing description taken in conjunction with the accompanying drawings.

### BRIEF DESCRIPTION OF DRAWINGS

FIG. 1

FIG. 1 is a control block diagram illustrating a configuration of a liquid crystal display device according to an embodiment of the present invention.

FIG. 2

FIG. 2 is a plan view schematically illustrating a structure of a pixel in a liquid crystal panel provided in the liquid crystal display device illustrated in FIG. 1.

FIG. 3

FIG. 3 is a table showing a result of measurements of response speeds of the liquid crystal when gradations are shifted in a case where the temperature of the liquid crystal panel of the liquid crystal display device according to an embodiment of the present invention is −30° C. FIG. 3(a) shows a case where d is 15.5 μm, FIG. 3(b) shows a case where d is 21.5 μm, and FIG. 3(c) shows a case where d is 25.0 μm.

FIG. 4

FIG. 4 is a table showing a result of measurements of response speeds of the liquid crystal when gradations are shifted in a case where the temperature of the liquid crystal panel of the liquid crystal display device according to an embodiment of the present invention is a normal temperature. FIG. 4(a) shows a case where d is 15.5 μm,

FIG. 4(b) shows a case where d is 21.5 μm, and FIG. 4(c) shows a case where d is 25.0 μm.

FIG. 5

FIG. 5 is a table showing a result of measurements of response speeds of the liquid crystal when gradations are shifted in a case where the temperature of the liquid crystal panel of the liquid crystal display device according to an embodiment of the present invention is 0° C. FIG. 5(a) shows a case where d is 15.5 μm, FIG. 5(b) shows a case where d is 21.5 μm, and FIG. 5(c) shows a case where d is 25.0 μm.

FIG. 6

FIG. 6 is a diagram illustrating an example of a gradation value shift process performed in the gradation conversion section in the liquid crystal display device illustrated in FIG. 1.

FIG. 7

FIG. 7 is a diagram for explaining a pseudo-multi-gradating process performed in the pseudo-multi-gradating section in the liquid crystal display device illustrated in FIG. 1.

FIG. 8

FIG. 8 is a diagram for explaining a pseudo-multi-gradating process performed in a pseudo-multi-gradating section in the liquid crystal display device illustrated in FIG. 1.

FIG. 9

FIG. 9 is a table showing a result of measurements of response speeds of the liquid crystal when gradations are shifted in a liquid crystal display device of TN mode according to another embodiment of the present invention.

FIG. 9(a) shows a case where a temperature of the liquid crystal panel is a normal temperature, and FIG. 9(b) shows a case where a temperature of the liquid crystal panel is −30° C.

### REFERENCE SIGNS LIST

10 Liquid Crystal Display Device

11 Liquid Crystal Panel

12 Backlight

13 Gate Driver

14 Source Driver

15 Backlight Driving Circuit

16 Display Controller

21 Gradation Conversion Section

22 Emphasis Conversion Calculator (Overshoot Calculation Section)

23 Pseudo-Multi-Gradating Section

24 Liquid Crystal Controller

31 Temperature Sensor

### DESCRIPTION OF EMBODIMENTS

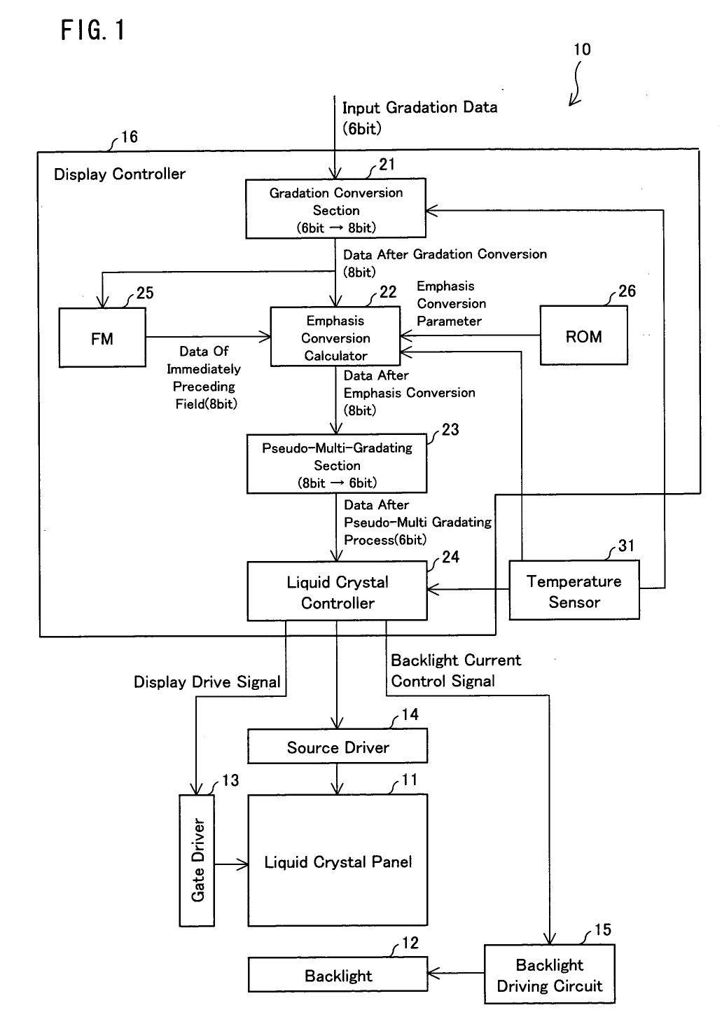

An embodiment of the present invention will now be described with reference to FIGS. 1 to 8. Note that the present invention is not limited thereto.

A liquid crystal display device according to the present embodiment performs displaying by using an overshoot driving. The overshoot driving is a display driving method for improving a response speed of liquid crystal. In the present embodiment, a liquid crystal display device, which includes a liquid crystal panel of a vertical alignment mode (VA mode) and polarizers disposed such that the liquid crystal display operates in a. normally black mode, is described by way of example.

In the present embodiment, an in-vehicle liquid crystal display device is also described by way of example. The in-vehicle liquid crystal display device is a device mounted in a vehicle for displaying information provided by various sensors and in-vehicle equipments. The in-vehicle liquid crystal device can also be used as a car navigation system, a television, and the like. In some cases where the in-vehicle liquid crystal display device is used in cold climates such as Northern Europe, the panel temperature of the in-vehicle liquid crystal display device may be as low as below the freezing point, or sometimes about −30° C. At such a low temperature, the response speed of liquid crystal drastically decreases when gradation values shift to white side. Therefore, the liquid crystal display device according to the present embodiment converts the gradation values so as not to use the upper gradation values of white side in a case where the liquid crystal display device is used at a low temperature.

FIG. 1 illustrates a configuration of a liquid crystal display device 10 according to the present embodiment. As illustrated in FIG. 1, the liquid crystal device 10 includes a liquid crystal panel 11, a backlight 12, a gate driver 13, a source driver 14, a backlight driving circuit 15, a display controller 16, and the like as main components.

The liquid crystal panel 11 is configured such that a liquid crystal layer is provided between an active matrix substrate and a counter substrate. The liquid crystal panel 11 according to the present embodiment is in a vertical alignment mode (VA mode), and polarizers are disposed such that the liquid crystal display device operates in a normally black mode.

The backlight 12 is provided on a backside of the liquid crystal panel 11 and irradiates the liquid crystal panel with light. The backlight driving circuit 15 controls turning on/off of the backlight 12, irradiation luminance of the backlight 12, and the like.

The display controller 16 generates a drive signal (display drive signal) for causing the liquid crystal panel 11 to display an image based on an image data signal (input gradation data) transmitted from an instrument panel control system (not illustrated). The display controller 16 includes a gradation conversion section 21 (gradation conversion section), an emphasis conversion calculator 22 (overshoot calculation section), a pseudo-multi-gradating section 23, a liquid crystal controller 24, a FM (Frame Memory) 25, and a ROM 26.

A temperature sensor 31 measures the surface of the liquid crystal panel 11. The temperature sensor 31 may be positioned on the surface of the liquid crystal panel 11 so that the temperature of the panel surface can directly be measured. Alternatively, the temperature sensor 31 may be provided at such a position that the temperature of the panel surface can be indirectly measured, so that the temperature of the liquid crystal panel 11 can be correlatively found based on the temperature measured at the position.

The instrument panel control system (not illustrated) generates an image data signal (input gradation data) for displaying an image on the liquid crystal panel 11 based on the information from various sensors attached to the vehicle, a position detector, and other in-vehicle devices (collectively termed “vehicle information”) or information inputted from an operation switch.

In the display controller 16, based on the information regarding the temperature of the liquid crystal panel transmitted from the temperature sensor 31, a gradation conversion process, an overshoot process, a pseudo-multi-gradating process, and the like are performed on the image data transmitted from the instrument panel control system (input gradation data). The details of the processes performed on the image data in the display controller 16 will be described later.

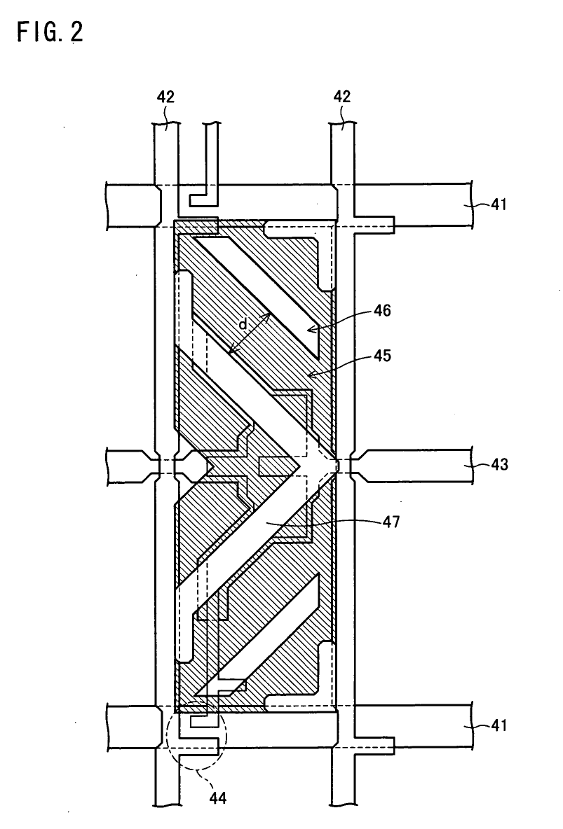

FIG. 2 illustrates a configuration of a pixel in the liquid crystal panel 11. While FIG. 2 mainly illustrates a planar structure of the active matrix substrate configuring the liquid crystal panel 11, a rib provided on the counter substrate to face the active matrix substrate is also shown for ease of explanation.

The liquid crystal panel 11 includes an active matrix substrate, a counter substrate, and a liquid crystal layer of vertical alignment type provided between these substrates. As illustrated in FIG. 2, on the active matrix substrate, there are formed a plurality of gate bus lines 41 arranged in parallel so as to extend in a transverse direction in the drawing and a plurality of source bus lines 42 arranged so as to extend in a longitudinal direction in the drawing and respectively intersect with the gate bus lines 41. Between two adjacent gate bus lines 41, an auxiliary capacitor wiring 43 is arranged in parallel with the gate bus lines.

In the vicinities of the respective intersections of the gate bus lines 41 and the source bus lines 42, TFTs 44 are provided as switching elements electrically connected to the gate bus lines 41 and the source bus lines 42. Furthermore, in each square of the grid formed by the gate bus lines 41 and the source bus lines 42 intersecting with each other, a pixel electrode 45 (shaded area in FIG. 2) is formed so that each pixel electrode 45 configures a pixel.

The pixel electrodes 45 are configured such that they are electrically connected to the TFTs 44, respectively. When scanning signals indicative of electrical conduction are inputted to the gate bus lines 41, the TFTs 44 connect the corresponding source bus lines 42 and the pixel electrodes 45 so that data signals transmitted to the source bus lines are inputted into the pixel electrodes 45. This allows each pixel electrode 45 to display based on the inputted data signal.

The pixel electrodes 45 are each provided with slits 46 for controlling the orientation of the liquid crystal molecules in the liquid crystal layer. On the counter substrate, a rib 47 for controlling the orientation of the liquid crystal molecules in the liquid crystal layer is provided. Such slits 46 and rib 47 cause an oblique electrical field to be formed when a voltage is applied, thereby allowing the liquid crystal molecules to be easily aligned at a tilt. As a result, the response speed of the liquid crystal can be increased.

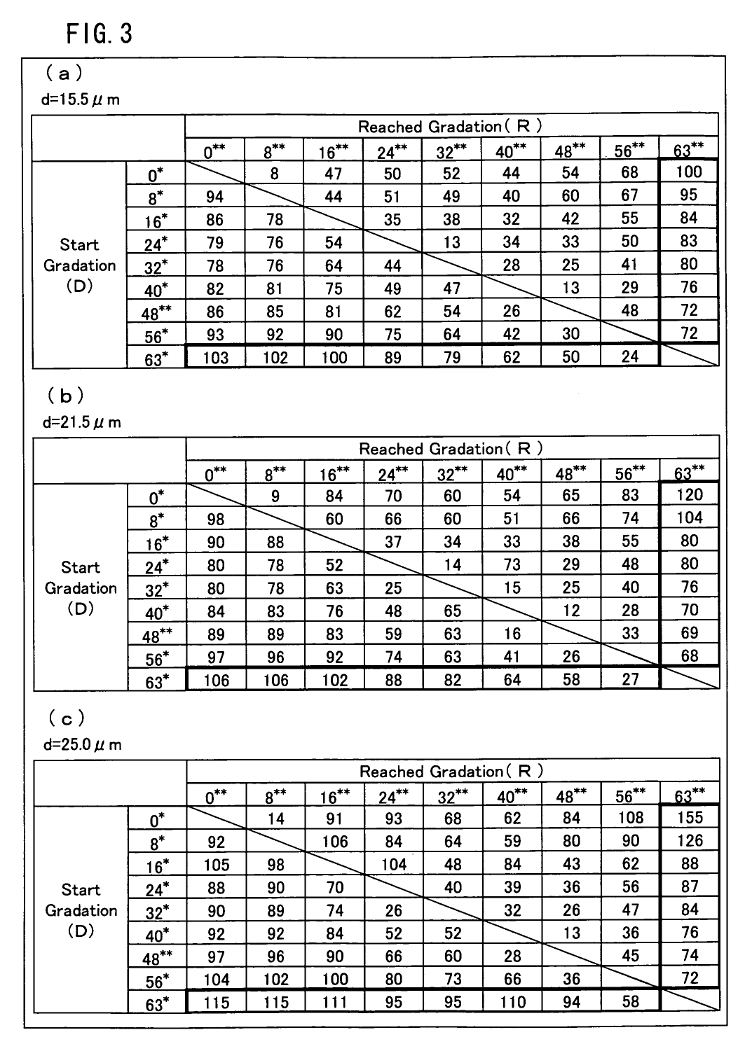

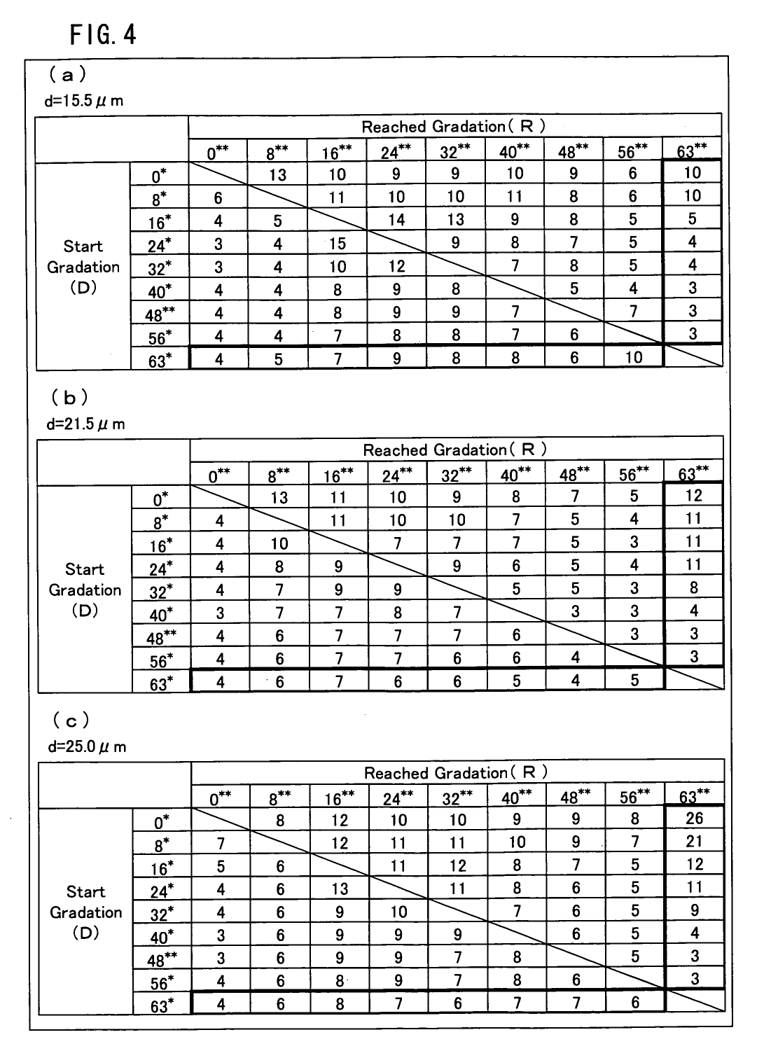

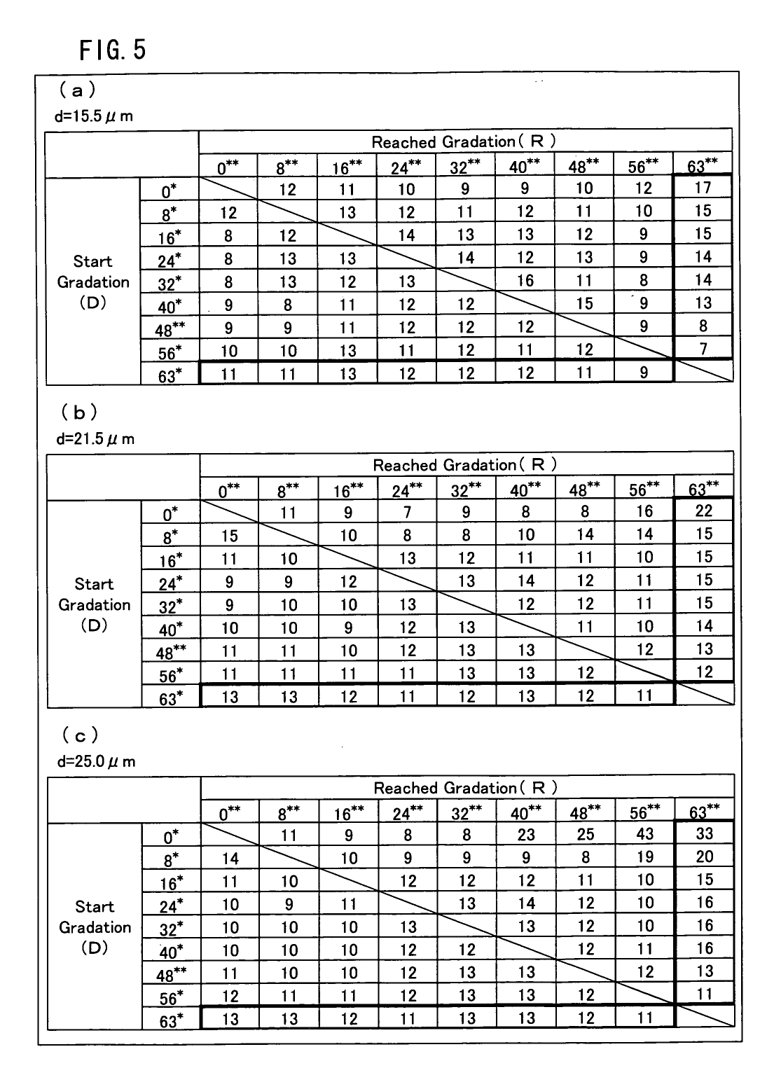

Assume that the distance between the slit 46 and the rib 47 arranged substantially parallel to each other is represented by d. The following shows the results of measurements of response speeds of the liquid crystal when gradations are shifted with respect to each of different d: FIG. 3 shows the result in a case where the temperature of the liquid crystal panel at the measurement was −30° C.; FIG. 4 shows the result in a case where the temperature of the liquid crystal panel at the measurement was a normal temperature (at approximately 25° C.); and FIG. 5 shows the result in a case where the temperature of the liquid crystal panel at the measurement was 0° C.

FIG. 3(a), FIG. 4(a), and FIG. 5(a) illustrate cases where d was 15.5 μm, FIG. 3(b), FIG. 4(b), and FIG. 5(b) illustrate cases where d was 21.5 μm, and FIG. 3(c), FIG. 4(c), and FIG. 5(c) illustrate cases where d was 25.0 μm.

In each of the tables shown in FIGS. 3 to 5, gradation values before the shift (start gradation) are indicated in the leftmost column and gradation values after the shift (reached gradation) are indicated in the uppermost row. The values indicated at the sections where these gradation values meet represent the response speeds when the gradation values before the shift transit to the gradation values after the shift. Here, a unit of the response speed is MS.

As shown in FIG. 4, at the normal temperature, the response speeds are sufficiently fast not only in cases where the gradation values shift between halftones but also in cases where the gradation values shift to high tone (white display) or low tone (black display). As such, no practical problem arises. It is noted that, when the distance d between the rib and the slit is 25 μm, the response speed slightly decreases. Therefore, it is preferable in an ordinary panel design that the distance d between the rib and the slit be smaller than 25 μm.

To the contrary, at the low temperature state of −30° C., the response speeds significantly decreased in comparison with the response speeds at the normal temperature, as shown in FIG. 3. These decreases in the response speeds become particularly prominent in cases where gradation values shift to the maximum gradation value of 63.

As such, when the liquid crystal display device is used at a low temperature, the upper gradation values of 57 to 63 that exhibit significant decreases in response speeds are not used. It is understood that this makes it possible to increase the response speeds by 10ms or more (refer to FIGS. 3(a) to 3(c)).

As shown in FIG. 5, at 0° C., the response speeds slightly decrease in comparison with the response speeds at the normal temperature.

Meanwhile, a common liquid crystal display has a guaranteed operation temperature range from 0° C. to 60° C. The liquid crystal display is thus generally configured such that desired characteristics are obtained in this temperature range. On the other hand, an in-vehicle liquid crystal panel has a guaranteed operation temperature range as wide as from −30° C. to 85° C., and in particular, the characteristics at 0° C. or below often come to an issue. Accordingly, from a perspective of improving low-temperature characteristics of the in-vehicle liquid crystal display, it is preferable that the threshold value be 0° C., which is a minimum value of the guaranteed operation temperature of a common liquid crystal display, and that consideration be made for improving the response speed of liquid crystal in a case where the temperature is lower than the threshold value.

Therefore, in light of the foregoing results and the characteristics of the liquid crystal panel, in a case where the temperature of the liquid crystal panel is equal to or lower than a predetermined temperature (for example, 0° C.), the liquid crystal display device 10 according to the present embodiment performs a gradation conversion process to shift the inputted gradation values to the gradation values lower than the inputted gradation values. This causes the upper gradation values near the white display (for example, gradation values from 57 to 63 in 6-bit data), whose response speed particularly decreases at a low temperature status, to go out of use. As a consequence, the decrease in the response speed can be curbed. The following describes an image data processing flow in the liquid crystal display device 10 with reference to FIG. 1 and FIGS. 6 to 8.

As illustrated in FIG. 1, an image data signal (input gradation data) inputted into the display controller 16 is first inputted into the gradation conversion section 21. Into the gradation conversion section 21, information on the surface temperature of the liquid crystal panel 11 measured by the temperature sensor 31 is also inputted. The gradation conversion section 21 decides, depending on the temperature information transmitted from the temperature sensor 31, whether or not to perform a conversion process for shifting the inputted gradation values to the lower gradation values (gradation conversion process).

For example, the gradation conversion section 21 decides whether or not to perform the foregoing gradation value shift process depending on whether the transmitted temperature information indicates not greater than 0° C. In other words, the gradation conversion section 21 performs the foregoing gradation value shift process when the transmitted temperature information indicates 0° C. or below. If the transmitted temperature information indicates higher than 0° C., the gradation conversion section 21 does not perform the foregoing gradation value shift process.

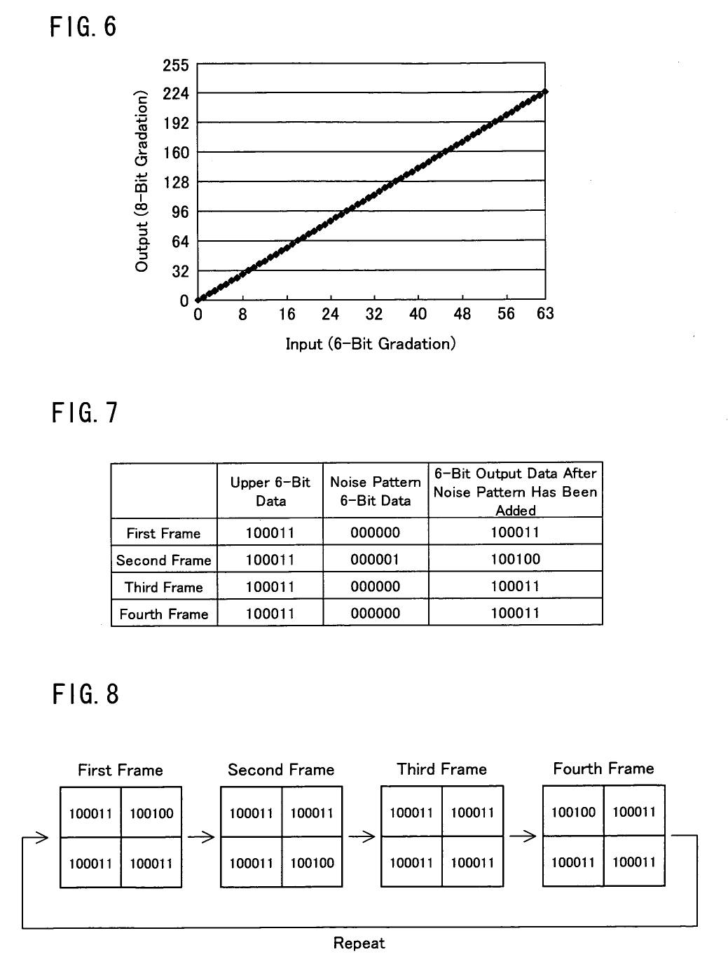

Now, an image data processing in a case where the transmitted temperature information indicates not greater than 0° C. is described. FIG. 6 illustrates an example in which the gradation conversion section 21 converts 6-bit input gradation data into 8-bit gradation data (data after gradation conversion) when the surface temperature of the liquid crystal panel 11 measured by the temperature sensor 31 is not greater than 0° C. In FIG. 6, the horizontal axis represents inputted gradation data (6 bits) and the vertical axis represents outputted gradation data (8 bits), and a relation between the inputted gradation and the outputted gradation is shown. As illustrated in FIG. 6, through the gradation conversion process in the gradation conversion section 21, the image data having gradation values of 0 to 63 is converted into image data having gradation values of 0 to 224.

If 6-bit input gradation data is simply converted into 8-bit image data, the image data is supposed to have gradation values of 0 to 255. Here, however, a conversion process is performed to shift the inputted gradation values to the gradation values lower than the inputted gradation values, so that the whole data after the conversion exists in the gradation range of 0 to 224. This corresponds to the gradation range of 0 to 56 in 6-bit image data. As shown in FIG. 3, if the gradation values range from 0 to 56, a decrease in the response speed when the gradations are shifted is not a very serious problem even at a temperature as low as −30° C. As such, the foregoing gradation value shift process is performed. This allows the high-tone side range, whose response speed significantly decreases in a low temperature state, to be unused.

The image data on which the gradation value shift process has been performed in the gradation conversion section 21 (data after gradation conversion) is next inputted into the emphasis conversion calculator 22 and the frame memory (FM) 25. The emphasis conversion calculator 22 carries out an overshoot process (overshoot calculation step). Specifically, the emphasis conversion calculator 22 compares image data (8 bits) of the immediately preceding field stored in the frame memory 25 with the current image data (8 bits) so as to find a gradation shift amount. Then, based on an emphasis conversion parameter stored in the ROM 26, the emphasis conversion calculator 22 outputs the image data after the overshoot process (data after emphasis conversion (8 bits)).

In the ROM 26, a plurality of pieces of data that correspond to temperatures are stored as emphasis conversion parameters so that an optimal emphasis conversion is performed depending on the temperature. The emphasis conversion calculator 22 selects, in accordance with the information from the temperature sensor 31, an optimal parameter from the plurality of parameters stored in the ROM 26. For this reason, the emphasis conversion calculator 22 receives feedback about the information from the temperature sensor 31.

The image data on which the overshoot process has been performed (data after emphasis conversion) is then inputted into the pseudo-multi-gradating section 23 where a pseudo-multi-gradating process is performed (pseudo-multi-gradating step).

The pseudo-multi-gradating section 23 carries out a pseudo-multi-gradating process on the image data with use of a known multi-gradation processing technique so that the gradation conversion performed in the gradation conversion section 21 does not cause nonsmooth gradation (i.e., so-called tone jump).

The pseudo-multi-gradating process is a process that makes a limited number of expressive gradations to appear as if increased to human eyes by using characteristics of human eyes that they recognize luminance by averaging luminance values in a given amount of time or in a given space. Depending on how large a unit of pixel region is or how noise patterns are designed (i.e., noise patterns of individual frames, the number of periodic frames, and the like), there are various types of pseudo-multi-gradating process including FRC.

As a specific method for performing the pseudo-multi-gradating process, for example, a method described in Patent Literature 2 can also be applied to the present invention.

In order to carry out such a pseudo-multi-gradating process, in the present embodiment, the gradation conversion section 21 converts 6-bit image data into 8-bit image data. Then, in the pseudo-multi-gradating section 23, the 8-bit image data is divided into upper 6 bits and lower 2 bits with use of a 6-bit driver. Based on the lower 2 bits, a 1-bit noise pattern is formed, which is superimposed on each pixel (upper 6 bits+1-bit noise pattern). In consequence, the 8-bit image data is converted into 6-bit image data again.

The image data on which the pseudo-multi-gradating process has been performed in the pseudo-multi-gradating section 23 (data after pseudo-multi-gradating process (6 bits)) is inputted into the liquid crystal controller 24. The liquid crystal controller 24 generates a display drive signal for causing the liquid crystal display 11 to display an image based on the inputted image data, and transmits the display drive signal to the gate driver 13 and the source driver 14. The liquid crystal panel 11 then displays an image based on various signals such as a scanning signal and a data signal transmitted from the gate driver 13 and the source driver 14.

The following describes, with reference to specific examples of gradation value conversions, how the gradation values are converted in the individual processing sections. Here, a case is described where the drivers driving the liquid crystal panel (the gate driver 13, the source driver 14) are 6-bit drivers and the input gradation data (image data) inputted into the display controller 16 is also 6-bit data. Note that the present invention is not limited thereto.

When the input gradation data inputted into the gradation conversion section 21 is 6-bit image data with a gradation value of 32 (i.e., 6-bit data of (100000)), the gradation conversion section 21 converts the data into 8-bit image data with a gradation value of 113 (i.e., 8-bit data of (01110001)). This 8-bit image data is then inputted into the emphasis conversion calculator 22 where a process for overshoot driving is performed thereon. In the emphasis conversion calculator 22, the 8-bit image data is converted into 8-bit data with a gradation value of 141 (i.e., 8-bit data of (10001101)).

The image data having been emphasis-converted for overshoot driving is then divided into upper 6-bit data (i.e., (100011)) and lower 2-bit data (i.e., (01)) in the pseudo-multi-gradating section 23. After that, based on the lower 2-bit data, an addition pattern of noise data (000000 or 000001) is decided for every frame. Then, image data to which the decided noise pattern is added is outputted.

FIG. 7 is a table showing, with regard to each frame (1st through 4th frame), an addition pattern of the noise data (000000) or (000001) decided based on the lower 2-bit data (01) and output data after the noise data has been added. In the example shown in FIG. 7, a unit period (which is referred to as a “frame period”) for obtaining a halftone display (a display having a luminance between the luminances represented by 6-bit gradation values) includes four frames. FIG. 8 illustrates an example in which displaying is carried out in four adjacent pixels by using output data after the noise data has been added.

Repeating these four frames averages the output data after the noise data has been added. As a result, the output data appears to human eyes as if 8-bit data (10001101) is outputted. This makes it possible to compensate for the number of gradations reduced by not using the upper gradation values with low response speed, thereby maintaining gradation expression ability.

In a case where the temperature of the liquid crystal panel 11 is 0° C. or below, the gradation value shift process performed by the gradation conversion section 21 causes upper gradation values with high luminance to be unused. Accordingly, the luminance of the displayed image decreases. To compensate for this decrease in luminance, the present embodiment controls the output of the backlight to be powered up in a case where the temperature of the liquid crystal panel 11 is 0° C. or below. This improves the luminance of the displayed image (backlight driving step). The following describes a flow of this process.

The information on the surface temperature of the liquid crystal panel 11 transmitted from the temperature sensor 31 is inputted into the liquid crystal controller 24. The liquid crystal controller 24 transmits, based on the transmitted temperature information, a signal for controlling the backlight 12 to the backlight driving circuit 15.

That is, in a case where the surface temperature information transmitted from the temperature sensor 31 indicates 0° C. or below, the gradation conversion section 21 performs a process for shifting the gradation values to the lower gradation values. Consequently, it is necessary to supply the backlight with current higher than usual so as to increase the luminance.

In view of this, when the transmitted temperature information indicates 0° C. or below, the liquid crystal controller 24 instructs the backlight driving circuit 15 to supply the backlight with current higher than usual (i.e., the liquid crystal controller 24 transmits a backlight current control signal). This causes the backlight driving circuit 15 to drive the backlight with higher current. The irradiation luminance of the backlight thus becomes higher than the irradiation luminance in a case where the gradation value shift process is not performed.

In contrast thereto, when the surface temperature information transmitted from the temperature sensor 31 indicates a temperature higher than 0° C., the gradation value shift process is not performed. That is, when the transmitted temperature information indicates a temperature higher than 0° C., the liquid crystal controller 24 instructs the backlight driving circuit 15 to drive the backlight with normal current.

As described above, adjusting the luminance of the backlight 12 makes it possible to compensate for the decrease in luminance caused by the gradation value shift process performed in the gradation conversion section 21.

It is problematic to supply the backlight with current higher than usual, because the reliability of the device may be damaged. Moreover, there is concern that disadvantage may be caused in terms of power consumption. However, even in a case where the ambient temperature is as low as 0° C. or below, after the liquid crystal display device is turned on, the temperature of the liquid crystal panel itself gradually increases to a temperature higher than 0° C. When the temperature of the liquid crystal panel is higher than 0° C., the foregoing gradation value shift process is not performed. Therefore, the operation of supplying the backlight with higher current is performed only immediately after the liquid crystal display device is turned on when the temperature of the liquid crystal panel is low.

Supplying the backlight temporarily with higher current immediately after the turning on of the liquid crystal display device makes it possible to increase the temperature of the liquid crystal panel in a shorter time. This offers an advantage of reaching, in a shorter time, the temperature area in which the response speed of the liquid crystal is higher. The increase in the temperature of the liquid crystal panel eliminates the need for performing the gradation value shift process. It is thus possible to set back the current supplied to the backlight to a normal level in a shorter time. As such, the problem regarding the reliability of the device can also be avoided.

The case where the temperature of the liquid crystal panel 11 is 0° C. or below was described so far. In contrast, the following describes a process flow in a case where the ambient temperature in which the liquid crystal display device 10 is used is higher than 0° C. or, as described above, in a case where the ambient temperature is 0° C. or below but the surface temperature of the liquid crystal panel 11 is higher than 0° C. because a certain period of time has passed since the turning on of the liquid crystal display device.

When the temperature of the liquid crystal panel 11 is higher than 0° C., a decrease in response speed is not a very serious problem in a normal panel design, as shown in FIG. 4. Therefore, the gradation conversion section 21, the emphasis conversion calculator 22, and the pseudo-multi-gradating section 23 do not perform a gradation value conversion process. The input gradation data is thus inputted into the liquid crystal controller 24 as it is. The liquid crystal controller 24 generates a display drive signal for causing the liquid crystal panel 11 to display an image based on the inputted input gradation data, and transmits the signal to the gate driver 13 and the source driver 14. The liquid crystal panel 11 displays an image based on the various signals such as a scanning signal and a data signal transmitted from the gate driver 13 and the source driver 14.

As described above, in the liquid crystal display device according to the present embodiment, the gradation conversion section 21 shifts the inputted gradation values to the gradation values lower than the inputted gradation values. This allows the gradation values of upper gradation side near white display to be unused. Taking 6-bit image data as an example, when gradation data with gradation values of 57 and more is inputted into the gradation conversion section 21, it is converted into gradation data with gradation value of 56 and less. This makes it possible to eliminate the gradation data with the gradation values of 57 and more from the displayed image.

In addition, deciding whether or not to perform the gradation value shift process depending on the temperature of the liquid crystal panel makes it possible to display an image without using gradation values of high tone side (white display side) whose response speed decreases, in a case where the temperature decreases, particularly significantly because the overshoot driving is ineffective. Thus, the gradation conversion section 21 converts gradation values so that the gradation values of the whole image data are in a range from halftone equal to or below a predetermined gradation value to low tone. This eliminates high-tone part near white display with a low response speed from the image to be displayed, thereby making it possible to obtain an image with a high response speed.

In addition, in the liquid crystal device according to the present embodiment, the pseudo-multi-gradating process is performed on the image data on which the gradation value shift process has been performed. This makes it possible to curb the deterioration in gradation expression ability arising from a decrease in the number of the gradations in use. In consequence, it is possible to curb deterioration in the display quality in a case where the liquid crystal display device is put in a low-temperature state.

In the foregoing embodiment, a case was described by way of example that a liquid crystal panel of vertical alignment (VA) mode was used to perform displaying in normally black mode. However, the present invention is not limited thereto. Similar effects are obtained also in a case where a liquid crystal panel of TN mode is used to perform displaying in normally white mode.

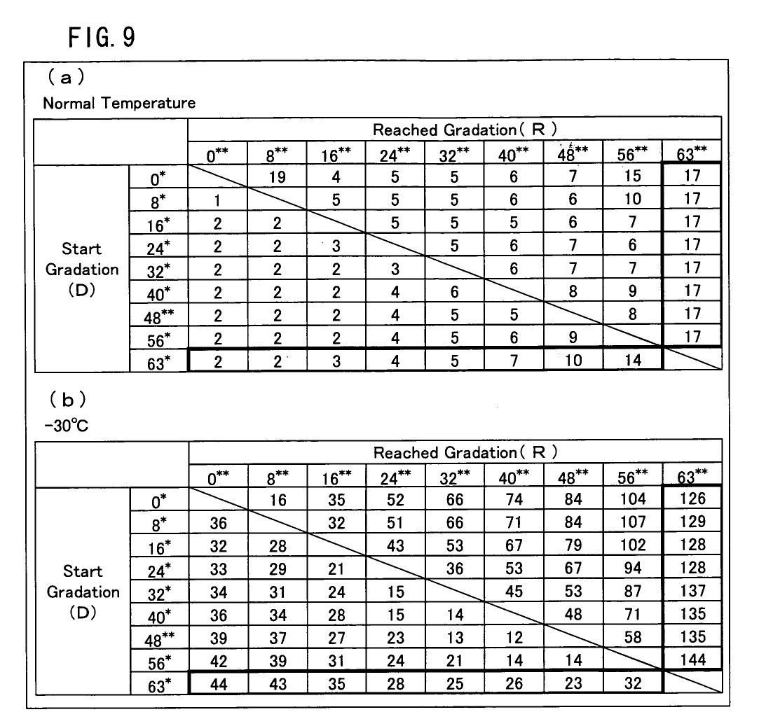

FIG. 9 shows a result of measurements of the response speeds of the liquid crystal at gradation shifts in a liquid crystal display device of TN mode. FIG. 9(a) illustrates a case where the temperature of the liquid crystal panel is a normal temperature, and FIG. 9(b) illustrates a case where the temperature of the liquid crystal panel is −30° C.

In each of the tables shown in FIG. 9, gradation values before the shift (start gradation) are indicated in the leftmost column and the gradation values after the shift (reached gradation) are indicated in the uppermost row. The values indicated at the sections where these gradation values meet represent the response speed when the gradation values before the shift transit to the gradation values after the shift. Here, a unit of the response speed is ms. As shown in FIG. 9(a), at the normal temperature, the response speeds are sufficiently fast not only in cases where the gradation values shift between halftones but also in cases where the gradation values shift to high tone (white display) or low tone (black display). As such, no practical problem arises.

To the contrary, as shown in FIG. 9(b), at the low temperature state of −30° C., the response speeds significantly decrease in comparison with the response speeds at the normal temperature. These decreases in the response speeds become particularly prominent in cases where gradation values shift to the maximum gradation value of 63.

As described above, in the liquid crystal display device of a TN mode, similarly to the liquid crystal display device of VA mode, a decrease in the response speed at the low temperature becomes a problem. Therefore, like the foregoing liquid crystal display device 10 according to the present embodiment, the liquid crystal display device of VA mode can be configured such that a gradation conversion process of shifting the inputted gradation values to the gradation values lower than the inputted gradation values is performed in a case where the temperature of the liquid crystal panel is a certain temperature (for example, 0° C.) or below. This causes the upper gradation values near white display (for example, the gradation values in a range from 57 to 63 in 6-bit data) whose response speed particularly decreases in a low-temperature state to be unused. As a result, a decrease in the response speed can be curbed.

The present invention is not limited to the foregoing embodiments and may be varied in many ways within the scope of the claims. That is, embodiments obtained by combining technical means arbitrarily varied within the scope of the claims are also included in the technical scope of the present invention.

As described above, a liquid crystal display device according to the present invention includes: a temperature sensor measuring a surface temperature of a liquid crystal panel; a gradation conversion section performing a gradation value shift process of shifting inputted gradation values to lower gradation values; and a pseudo-multi-gradating section performing a pseudo-multi-gradating process on image data on which the gradation value shift process has been performed by the gradation conversion section, and the gradation conversion section decides whether or not to perform the gradation value shift process depending on the surface temperature of the liquid crystal panel measured by the temperature sensor.

Further, as described above, a method for driving a liquid crystal display device according to the present invention includes: a gradation conversion step of deciding whether or not to perform a gradation value shift process for shifting inputted gradation values to lower gradation values depending on the surface temperature of the liquid crystal panel measured by the temperature sensor; and a pseudo-multi-gradating step of performing a pseudo-multi-gradating process on an image data on which the gradation value shift process has been performed in the gradation conversion step.

Therefore, according to the present invention, high-tone part near white display with a low response speed is eliminated from the image to be displayed, which makes it possible to obtain an image with a high response speed. Moreover, according to the present invention, the pseudo-multi-gradating process is performed on the image data on which the gradation value shift process has been performed. This can curb a decrease in gradation expression ability caused by a decrease in the number of gradations in use. As a result, it is possible to curb deterioration in display quality in a case where the liquid crystal display device is put in a low-temperature environment.

The specific embodiments or examples described in the detailed description of the invention are solely intended to disclose the techniques of the present invention and should not be narrowly interpreted as limiting to such specific examples. The embodiments and examples may be varied in many ways without departing from the spirit of the present invention.

### INDUSTRIAL APPLICABILITY

With use of the liquid crystal display device according to the present invention, it is possible to curb a decrease in response speed of gradation shift to white display at a low temperature. It is further possible to maintain the gradation expression ability and to curb deterioration in the display quality. Accordingly, the liquid crystal display deice according to the present invention can preferably be applied to an in-vehicle display device used at a low temperature.

1. A liquid crystal display device displaying an image by using overshoot driving, comprising:
a temperature sensor measuring a surface temperature of a liquid crystal panel;
a gradation conversion section performing a gradation value shift process of shifting inputted gradation values to lower gradation values; and
a pseudo-multi-gradating section performing a pseudo-multi-gradating process on image data on which the gradation value shift process has been performed by the gradation conversion section,
the gradation conversion section deciding whether or not to perform the gradation value shift process depending on the surface temperature of the liquid crystal panel measured by the temperature sensor.

2. The liquid crystal display device according to claim 1, wherein:
the gradation conversion section performs the gradation value shift process when the surface temperature of the liquid crystal panel measured by the temperature sensor is 0° C. or below.

3. The liquid crystal display device according to claim 1 further comprising:
a backlight irradiating the liquid crystal panel with light; and
a backlight driving section adjusting luminance of the light irradiated by the backlight,
wherein:
the backlight driving section adjusts the luminance of the light irradiated by the backlight so that irradiation luminance is higher when the gradation conversion section performs the gradation value shift process than when the gradation conversion section does not perform the gradation value shift process.

4. The liquid crystal display device according to claim 1, wherein:
the gradation conversion section performs the gradation value shift process of shifting the inputted gradation values to the lower gradation values while converting n-bit input image data (where n is an integer) into m-bit image data (where m is an integer) whose number of bits is larger than the number of bits of the n-bit input image data and outputting the m-bit image data; and
the pseudo-multi-gradating section performs a pseudo-multi-gradating process on the m-bit image data so as to output as n-bit image data.

5. The liquid crystal display device according to claim 1, further comprising:
an overshoot calculation section performing an overshoot calculation on the image data on which the gradation value shift process has been performed by the gradation conversion section.

6. A method for driving a liquid crystal display device displaying an image by using overshoot driving, the liquid crystal display device including a temperature sensor measuring a surface temperature of a liquid crystal panel, the method comprising:
a gradation conversion step of deciding whether or not to perform a gradation value shift process for shifting inputted gradation values to lower gradation values depending on the surface temperature of the liquid crystal panel measured by the temperature sensor; and
a pseudo-multi-gradating step of performing a pseudo-multi-gradating process on an image data on which the gradation value shift process has been performed in the gradation conversion step.

7. The method according to claim 6, wherein:
in the gradation conversion step, the gradation value shift process is performed when the surface temperature of the liquid crystal panel measured by the temperature sensor is 0° C. or below.

8. The method according to claim 6, wherein
the liquid crystal display device includes a backlight irradiating the liquid crystal panel with light, and
the method further comprises a backlight driving step of adjusting luminance of the light irradiated by the backlight,
the luminance of the light irradiated by the backlight being adjusted in the backlight driving step so that irradiation luminance of the light is higher when the gradation value shift process is performed in the gradation conversion step than when the gradation value shift process is not performed in the gradation conversion step.

9. The method according to claim 6, wherein:
in the gradation conversion step, n-bit input image data (where n is an integer) is converted into m-bit image data (where m is an integer) whose number of bits is larger than the number of bits of the n-bit input image data and the m-bit image data is outputted; and in a case where the gradation value shift process is performed, the gradation value shift process of shifting the inputted gradation values to the lower gradation values is performed while converting the n-bit input image data into m-bit image data; and
in the pseudo-multi-gradating step, a pseudo-multi-gradating process is performed on the m-bit image data so as to output as n-bit image data.

10. The method according to claim 6, further comprising:
an overshoot calculation step of performing an overshoot calculation on the image data on which the gradation value shift process has been performed in the gradation conversion step.

11. A liquid crystal display device displaying an image by using overshoot driving, comprising:
a temperature sensor measuring a surface temperature of a liquid crystal panel;
a gradation conversion section performing a gradation value shift process of shifting inputted gradation values to lower gradation values;
a pseudo-multi-gradating section performing a pseudo-multi-gradating process on an image data on which the gradation value shift process has been performed by the gradation conversion section;
a backlight irradiating the liquid crystal panel with light; and
a backlight driving section adjusting luminance of the light irradiated by the backlight,
the gradation conversion section deciding whether or not to perform the gradation value shift process depending on the surface temperature of the liquid crystal panel measured by the temperature sensor, and
the backlight driving section adjusting the luminance of the light irradiated by the backlight so that irradiation luminance is higher when the gradation conversion section performs the gradation value shift process than when the gradation conversion section does not perform the gradation value shift process.
